(19) United States
(12) Patent Application Publication
(10) Pub. No.: US 2018/0058700 A1
(43) Pub. Date: Mar. 1, 2018

(54) TEMPERATURE CONTROL FOR BURNER OF A COOKING APPLIANCE

(71) Applicant: Therm-O-Disc, Incorporated, Mansfield, OH (US)

(72) Inventors: Kellene Perry, Delaware, OH (US); Charles Volz, Mansfield, OH (US); Richard Rudolph, St. Louisville, OH (US)

(21) Appl. No.: 15/254,618

(22) Filed: Sep. 1, 2016

(51) Int. Cl. F24C 7/08; F24C 3/12; H05B 1/02

(52) U.S. Cl. CPC F24C 7/088; H05B 1/0213; H05B 1/0266; F24C 3/122

(57) ABSTRACT

A top cooking appliance is provided having a cooktop with a surface heating unit and a thermally-responsive control device that can include a temperature-sensing thermal switch for controlling the operation of the surface heating unit. When the thermal switch senses that the cooking temperature exceeds a first, predetermined upper threshold temperature, the device can cause an interruption in the operation of the surface heating unit. The thermally-responsive control device can then restore the operation of the surface heating unit when the thermal switch senses that the cooking temperature falls below a second predetermined, lower threshold temperature. The thermally-responsive control device for cooktop burners of the present disclosure can be incorporated in both electric and gas-operated top cooking appliances.

### FIELD

The present disclosure relates to a temperature control for surface heating units, or burners, of cooking appliances. More particularly, the present disclosure relates to a thermally-responsive control device for cooktop surface heating units that can include a thermal switch for controlling the operation of a burner of a cooking appliance.

### BACKGROUND

This section provides background information related to the present disclosure which is not necessarily prior art.

“Top-cooking” appliances are well-known. One of the most familiar top-cooking appliances includes a cooktop having one or more burners upon which cookware (e.g., pots, pans, skillets, and the like) for cooking food items are placed. Stoves and ranges are popular cooking appliances having a cooktop. The cooktop burners can be electrically powered or gas-fueled. An electrically-powered burner generally includes exposed electric coil heating elements having an electrical resistance core embedded within an alloy sheath and wound in the shape of concentric circles with multiple “turns” to the winding. The cookware rests directly on the coil during cooking. Gas-fueled burners generally include a cap which distributes a gas flame in a circular pattern beneath a grate upon which the cookware is placed.

Cooking appliance standards classify top cooking appliances as “attended cooking” devices. This means that the user should be present to visually observe the heat source and the progress of the food being prepared. Typically, electrical indicators illuminate to show an active electrical element and gas-fueled burners' flames can be observed. The cookware and the food under preparation may also require periodic attention, such as stirring or draining, to prevent burning and/or boiling over. Attended cooking also involves the user making manual control adjustments to regulate cooking heat as needed. This may include, e.g., turning down the heat setting once a boil has been established.

Many cooking accidents can be attributed to the user of a cooking appliance leaving the appliance unattended during cooking. While the user is not present to make heat setting adjustments, pots of liquids may boil over or boil dry, or cooking oils may overheat to their flashpoint and ignite, thereby starting a fire which can be extremely hazardous.

As such, in recent years, a UL-858 specification has been proposed and is intended to reduce and/or minimize the occurrence of fires resulting from unattended cooking. The specification requires top-cooking appliance manufacturers to control or limit the temperature of the burners. The specification stipulates that when a burner holding an uncoated aluminum frying pan, which is wider than the burner and contains ⅛″ of canola oil, is set to the maximum temperature setting for thirty minutes, the oil may not ignite. In order to prevent the oil from igniting, the pan must remain below 370 degrees Celsius, which is the flash point for canola oil.

However, this regulation provides the challenge of preventing the pan from reaching the flash point of canola oil (i.e., 370 degrees Celsius), while ensuring cooking performance is not hindered. A means of achieving this also ideally will not add substantial cost, reliability, or serviceability issues with the cooking appliance. Current solutions use electronics to control the burner temperature, which are very costly and not viable for lower-end stove models.

U.S. Pat. No. 9,220,130 provides a method and devices for controlling the temperature of kitchen cookware on the burner of an electric range. Specifically, the device describes a temperature sensing switch which is located within the drip pan cavity of a burner of an electric range. Heat is detected by the switch via radiation. However, the arrangement places the switch in very close proximity to the heating element, exposing the switch to very high temperatures and outside the standard limits of many temperature-controlled switches. Moreover, because the switch is located within the drip pan of the burner, it is exposed to cooking debris and, therefore, can be susceptible to malfunction. Still further, the electric coil heating element and the switch are not readily serviceable independent from one another.

Therefore, it remains desirable to provide a temperature control to control the operation of a cooktop burner element of a cooking appliance to reduce the opportunity for overheating of the burner element and/or the cooktop, that is effective and accurate, operates in a temperature range of known temperature controls, and is readily serviceable and/or replaceable.

### SUMMARY

The present disclosure provides a thermally-responsive control device for cooktop surface heating units, or burners, of top cooking appliances.

An electric cooking appliance is provided including a thermally-conductive cooktop having an outer perimeter, an upper surface, a lower surface, and an opening. A surface heating unit comprising an electric coil heating element and a drip pan positioned below the electric coil heating element is disposed in the opening. A power terminal is mounted to the lower surface of the cooktop near the surface heating unit. The electric coil heating element is electrically connected in series to the power terminal. A temperature sensing electrical switch that is electrically connected in series with the power terminal and the electric coil heating element, is mounted against the lower surface of the cooktop and between the outer perimeter and the opening. The temperature sensing electrical switch is operable to sense a temperature of the cooktop and to interrupt the electrical connection to one of the power terminal and the electric coil heating element when the temperature of the cooktop is at a first, predetermined upper threshold and to restore the electrical connection to one of the power terminal and the electric coil heating element when the temperature of the cooktop is at a second, predetermined lower threshold.

The temperature sensing electrical switch can include a snap-acting, bi-metal disc having an operating range of about 50 degrees Celsius to 250 degrees Celsius.

In another embodiment, a gas cooking appliance is provided including a thermally-conductive cooktop having an outer perimeter, an upper surface, a lower surface, and an opening. A surface heating unit comprising a gas-fueled heating element, a grate, and a solenoid-operated gas valve is positioned below the upper surface of the cooktop is disposed in the opening. A temperature sensing electrical switch is mounted against the lower surface of the cooktop and between the outer perimeter and the opening. The temperature sensing electrical switch is electrically connected in series to the solenoid-operated gas valve. The temperature sensing electrical switch is operable to sense a temperature of the cooktop and to close the gas valve when the temperature of the cooktop is at a first, predetermined upper threshold and to open the gas valve when the temperature of the cooktop is at a second, predetermined lower threshold.

The thermally-responsive control device of the present disclosure can be mounted under the cooktop, between an outside perimeter wall of the cooktop and the cooktop surface heating unit. The thermally-responsive control device is protected from food debris and avoids commonly used areas of the cooktop surface, so to limit the possibility that other heat sources or heat sinks could interfere with the operation of the control device. Further, the thermally-responsive control device is in close proximity to existing power sources and components of the surface heating unit. Any necessary lead wires for the control can be contained beneath the cooktop and improves the ease of accessing the control for service or replacement.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic block diagram of a temperature control for a top cooking appliance according the present disclosure;

FIG. 2 is a top perspective view of an electric cooking appliance incorporating the temperature control according the present disclosure;

FIG. 3 is a cross-sectional view taken along line 3-3 of FIG. 2;

FIG. 4A is a front perspective view of a temperature sensing switch and mounting bracket assembly according to the present disclosure in a free position;

FIG. 4B is a front perspective view of a temperature sensing switch and mounting bracket assembly according to the present disclosure in an installed position; and

FIG. 5 is a schematic block diagram of an alternate embodiment of a temperature control for a top cooking appliance according to the present disclosure.

Corresponding reference numerals indicate corresponding parts throughout the several views of the drawings.

### DETAILED DESCRIPTION

Example embodiments will now be described more fully with reference to the accompanying drawings.

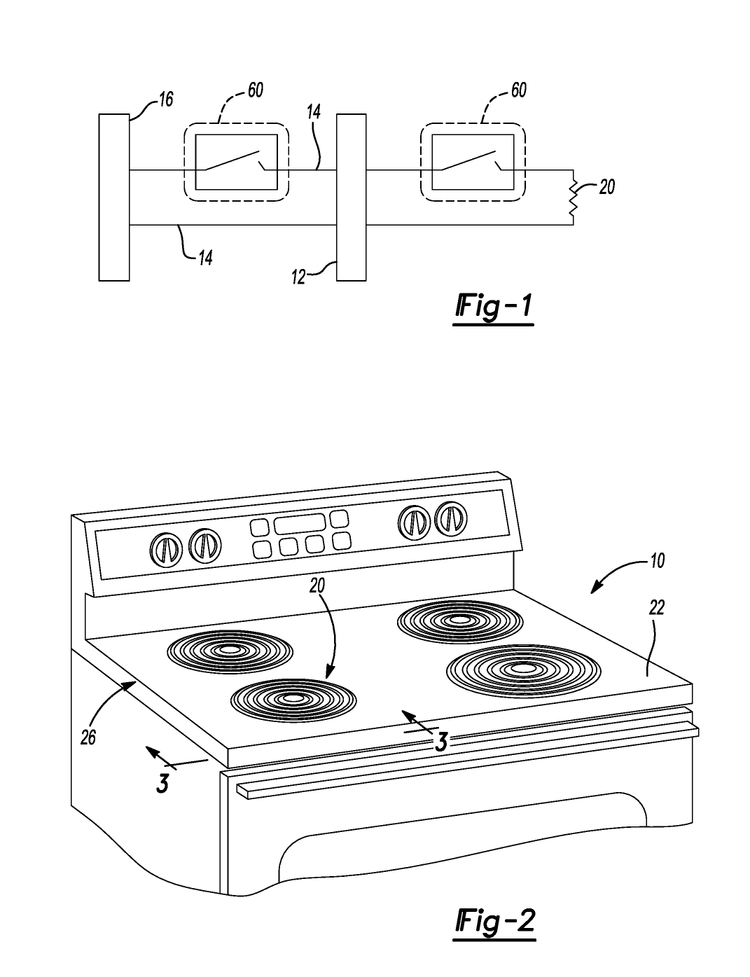

As shown in the Figures, the present disclosure provides a thermally-responsive control device for cooktop surface heating units, or burners, that can include a temperature-sensing control (e.g., a thermal switch) for controlling the operation of a burner of a cooking appliance. Referring to FIG. 1, which shows a schematic block diagram of a thermally-responsive control device of the present disclosure, a temperature-sensing control 60 can be disposed intermediate a power source 16 and the burner 20 of a cooking appliance. When the temperature-sensing control 60 senses that the cooking temperature exceeds a first, predetermined upper threshold temperature, the control 60 can cause an interruption in the connection between the power source 16 and the burner 20. The temperature-sensing control 60 can then restore the connection between the power source 16 and the burner 20 when the control 60 senses that the cooking temperature falls below a second predetermined, lower threshold temperature. The temperature-sensing control for cooktop burners of the present disclosure can be incorporated in both electric and gas-operated cooking appliances. The temperature-sensing control for cooktop burners of the present disclosure can aid in the prevention of and/or reduction of occurrences whereby objects being cooked on the cooking appliance can ignite, particularly while the cooking appliance is unattended.

For example, FIG. 2 shows a top perspective view of an electric cooking appliance, including a cooktop 10. The cooktop 10 can include an upper surface 22, a lower surface 24, and an outer wall 26 defining a perimeter of the cooktop. A plurality of surface heating units or burners 20 is included in the cooktop 10. Individual burners 20 are located in respective openings 30 in the upper surface 22 of the cooktop 10. The burners 20 can be of a type well-known in the industry and can include an electrically-powered resistance coil heating element positioned near the upper surface 22 of the cooktop 10, a drip pan 30 positioned beneath the heating element 20 and below the lower surface 24 of the cooktop 10, and a power terminal 12. Each of the heating elements 20 is electrically connected to a respective power terminal 12 which provides current from an electric power source 16. The cooktop is typically made of metal, and is thermally conductive.

Although a free-standing electric cooking appliance having a cooktop 10 is shown, it is to be understood that a slide-in, drop-in, or any other cooking appliance with a cooktop 10 may be contemplated. Further, the numbers and sizes of the surface heating units may vary. For example, an electric cooking appliance could have one, two, four, or six surface heating units 20 and in 4 inch, 6 inch or 8 inch diameters.

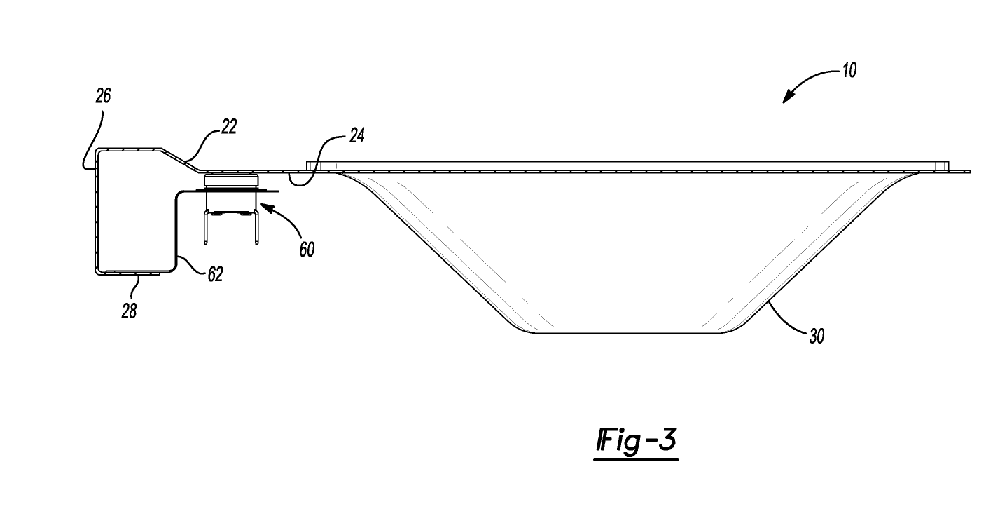

Turning to FIG. 3, a portion of the cooking appliance of FIG. 2 is illustrated in cross-section. As shown, a burner 20 is located in an opening 30 through the cooktop 10. The temperature sensing control 60 can be mounted against the lower surface 24 of the cooktop 10 to promote good thermal conductivity with the cooktop. The control 60 can be positioned between the drip pan 30 and the outer wall 26 of the cooktop. While one exemplary location of the temperature sensing control 60 is shown in FIG. 3, it is contemplated that the control 60 may be mounted in varying locations against the lower surface 24 of the cooktop.

The control 60 can be electrically connected in series with a power terminal 12, also be mounted to the cooktop, and the heating element 20. Lead wires 14 electrically connecting the control to the power terminal 12 for the heating element 20 can be affixed to the lower surface 24 of the cooktop by way of a bracket, tape, or similar means. The control serves as a switch capable of opening/closing the electric circuit and interrupting/restoring power to the heating element responsive to temperature. A suitable temperature-sensing control for use in the present disclosure includes a commercially-available bi-metal snap-disc temperature control from Therm-O-Disc, Incorporated, that is offered under the 36T series designation. The control can be calibrated to open and/or close at predetermined temperatures (or temperature ranges).

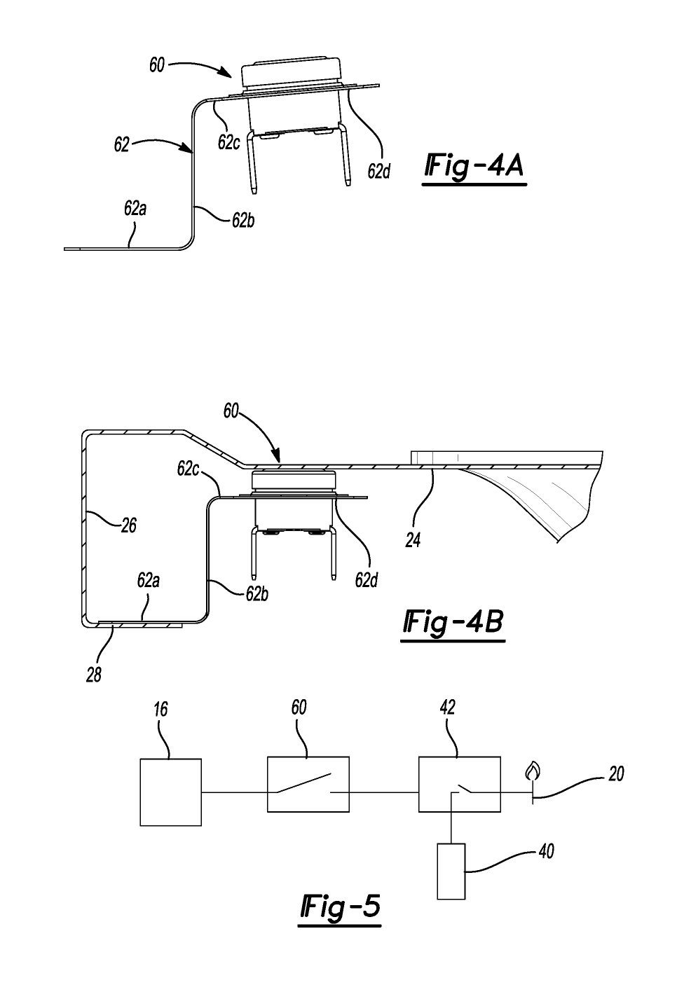

The control 60 is preferably positioned against the lower surface 24 of the cooktop 10 such that the control rests or seats squarely against the metal cooktop. With reference to FIGS. 4A and 4B, the temperature sensing control 60 is mounted against the lower surface 24 of the cooktop 10 by a bracket 62. The bracket supports the control against the lower surface 24 of the cooktop 10. Preferably, the bracket serves to bias the control against the lower surface 24 of the cooktop so as to promote good contact and thermal conductivity between the control 60 and the metal cooktop 10. As shown, the bracket 62 generally has a one-piece, “S”-shaped construction and includes an upper flange 62c and a lower flange 62a connected by an extension portion 62b. The upper flange 62c includes an aperture 62d through which the control 60 can be mounted, and supports the control above and laterally off-set from the lower flange 62a. The lower flange 62a provides a location for the bracket 62 to be fastened to the cooktop 10. For example, the bracket 62 can be affixed to the cooktop 10, such as at a lip 28 located at the perimeter 26 of the cooktop and below the lower surface 24, such as by welding or any other suitable method. Alternatively, the bracket can take the form of a “U”-shaped bracket, or as a generally planar or curved strap that is affixed to the cooktop.

Preferably, the bracket 62 can possess a spring-like bias so as to support the control firmly against the lower surface 24 of the cooktop 10 when fixed to the cooktop. For example, in a relaxed state, one or both of the upper flange 62c and the lower flange 62a can form an angle of greater than 90 degrees with the extension portion 62b. When the control 60 is mounted to the bracket 62, then, and the bracket 62 is affixed to the cooktop 10, the control 60 is seated against the lower surface 24 of the cooktop 10 causing the bracket 62 to be placed under a compressive force. This, in turn, causes the upper and/or lower flanges to flex to a state producing a reaction force bias firmly pressing the control against the lower surface of the cooktop.

In operation, the thermally-responsive control can detect temperature changes in the cooktop when an associated burner of the cooking appliance is in use. In particular, heat generated by the burner is carried to the cooktop by convection and/or radiation, causing the metal cooktop to become heated. The heat is then conducted through the metal cooktop, from the openings in which the burners are located, toward the outer wall at the perimeter of the cooktop. The control, which is in good contact with the lower surface of the cooktop, senses any rise in temperature. If the temperature reaches a first, predetermined upper threshold temperature, then the control can open the electric circuit and interrupt power (i.e., current) to the heating element, causing it to shut down. Interrupting the power to the heating element 20 in such circumstances can help prevent the further heating of an object being prepared on the cooktop which, in turn, can help reduce the likelihood that the object could ignite while being cooked on the cooking appliance. Thereafter, if the temperature falls to a second, predetermined lower threshold, the control can close the electric circuit and enable power to the heating element. The first, predetermined upper threshold temperature can be greater than the second, predetermined lower threshold temperature.

The first and second predetermined threshold temperatures can be calibrated based on the mounting location of the control on the cooktop and the temperature “noise” produced by extraneous temperature sources (e.g. an oven, other burners, etc.) in the cooking appliance. A preferred mounting location of the control on the cooktop is between the outer wall of the cooktop and the drip pan of the respective burner with which the control is associated. One combination of calibration temperatures for the control includes 110 degrees Celsius for the first, predetermined upper threshold and 101.5 degrees Celsius for the second, predetermined lower threshold. The combination of calibration temperatures and control mounting location enables the UL-858 specification to be met.

Additionally, a preferred location of the control on the cooktop provides the advantage of proximity to the power terminal for supplying power to the electric heating element. Also, a preferred location is less likely to support items or utensils that could act as a heat sink or heat source, which could impact the temperature of the cooktop that is sensed by the control. Further, a preferred location against the lower surface of the cooktop is protected from food debris, but is still easily accessible for service. Additionally, a preferred location enables any lead wires to and from the control, the power terminal and the heating element to be fastened neatly to the underside of the cooktop surface.

While the disclosure shows a single control associated with a single electric coil heating element 20, it should be understood that multiple controls 60 can be associated with multiple heating units 20 on a cooktop 10. For example, a cooktop 10 may have four separate surface heating units 20 electrically controlled by four separate controls 60, each of which may be calibrated the same or differently.

With regard to FIG. 5, in an alternate embodiment of the present disclosure, the control can also be adapted for use in a gas-fueled cooking appliance. In this regard, the control 60 can be connected electrically in series with a solenoid-operated valve 42 for a gas burner 20 of the appliance. As such, based on the temperature sensed by the control 60, the control can interrupt electrical power to the solenoid-operated valve 42 and thereby control the opening and closing of the valve and the flow of gas to the burner.

A gas-fueled cooking appliance can include a cooktop 10 having one or more gas-fueled surface heating elements or burners 20. In a similar configuration as the cooktop of FIG. 2, a gas-fueled appliance cooktop has a perimeter, an upper surface 22, a lower surface 24, an outer wall 26 defining a perimeter of the cooktop, and one or more gas-fueled burners 20. Each gas-fueled burner 20 can include a solenoid-operated valve 42 for controlling the flow of gas to the burner 20 and a power terminal 12. The solenoid-operated valve 42 is electrically operated and controls the opening and closing of the valve. Similarly to that previously discussed, the control can be mounted to the lower surface 24 of the cooktop 10 near the burner 20 and between the outer wall 26 of the cooktop 10 and the drip pan 30. The control 60 can be electrically connected in series to the solenoid-operated valve 42 and be operable as a switch capable of opening/closing the electric circuit and interrupting/restoring power to solenoid-operated valve which, in turn, opens and closes the valve for supplying gas fuel to the burner.

In operation, the thermally-responsive control can detect temperature changes in the cooktop when an associated burner of the cooking appliance is in use. The control, which is in good contact with the lower surface of the cooktop, senses any rise in temperature. Similarly as previously described, if the temperature reaches a first, predetermined upper threshold temperature, then the control can open the electric circuit and affect operation of the solenoid-operated valve, e.g., interrupting power to the solenoid causing the valve to close and shutting off the flow of gas fuel to the burner, causing the burner to shut down. Thereafter, if the temperature falls to a second, predetermined lower threshold, the control can then close the electric circuit and enable power to the solenoid-operated valve, and thereby restore the flow of gas fuel to the burner. As discussed above, the first, predetermined upper threshold temperature can be greater than the second, predetermined lower threshold temperature.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric cooking appliance, comprising:
a thermally-conductive cooktop having an outer perimeter, an upper surface, a lower surface, and an opening therethrough;
a surface heating unit comprising an electric coil heating element and a drip pan positioned below the electric coil heating element, the surface heating unit being disposed in the opening;
a power terminal mounted to the lower surface of the cooktop near the surface heating unit, the electric coil heating element being electrically connected in series to the power terminal;
a temperature sensing electrical switch electrically connected in series with the power terminal and the electric coil heating element; and
wherein the temperature sensing electrical switch is mounted against the lower surface of the cooktop, wherein the temperature sensing electrical switch is operable to sense a temperature of the cooktop and to interrupt the electrical connection to one of the power terminal and the electric coil heating element when the temperature of the cooktop is at a first upper threshold and to restore the electrical connection to one of the power terminal and the electric coil heating element when the temperature of the cooktop is at a second lower threshold.

2. The electric cooking appliance of claim 1 wherein the temperature sensing electrical switch is mounted between the outer perimeter and the opening.

3. The electric cooking appliance of claim 1, wherein the temperature sensing electrical switch is electrically connected in series intermediate the power terminal and the electric coil heating element.

4. The electric cooking appliance of claim 2, wherein the temperature sensing electrical switch is electrically connected in series intermediate the power terminal and a power source.

5. The electric cooking appliance of claim 4, further comprising a mounting bracket, the mounting bracket attached to the cooktop and supporting the temperature sensing electrical switch against the lower surface of the cooktop.

6. The electric cooking appliance of claim 5, wherein the mounting bracket comprises means for biasing the temperature sensing electrical switch against the lower surface of the cooktop.

7. The gas cooking appliance of claim 5, wherein the mounting bracket comprises a first flange and a second flange connected by an extension portion, wherein the first flange comprises a mounting aperture for the temperature sensing electrical switch and supports the temperature sensing electrical switch above and laterally off-set from the lower flange.

8. The gas cooking appliance of claim 7, wherein at least one of the first flange and the second flange form an angle of greater than 90 degrees with the extension portion.

9. The electric cooking appliance of claim 1, wherein the first, upper threshold is about 110 degrees Celsius and the second, lower threshold is about 101.5 degrees Celsius

10. The electric cooking appliance of claim 9, wherein the temperature sensing electrical switch comprises a snap-acting, bi-metal disc having an operating range of about 50 degrees Celsius to 250 degrees Celsius.

11. The electric cooking appliance of claim 1, wherein lead wires connect the power source, the temperature sensing electrical switch and the power terminal, and wherein the lead wires are affixed to the lower surface of the cooktop.

12. A gas cooking appliance, comprising:
a thermally-conductive cooktop having an outer perimeter, an upper surface, a lower surface, and an opening therethrough;
a surface heating unit comprising a gas-fueled heating element, a grate, and a solenoid-operated gas valve positioned below the upper surface of the cooktop, the surface heating unit being disposed in the opening;
a temperature sensing electrical switch mounted to the lower surface of the cooktop and being electrically connected in series to the solenoid-operated gas valve; and
wherein the temperature sensing electrical switch is mounted against the lower surface of the cooktop and between the outer perimeter and the opening, the temperature sensing electrical switch being operable to sense a temperature of the cooktop and to cause the solenoid to close the gas valve when the temperature of the cooktop is at a first, predetermined upper threshold and to open the gas valve when the temperature of the cooktop is at a second, predetermined lower threshold.

13. The gas cooking appliance of claim 12, further comprising a mounting bracket, the mounting bracket attached to the cooktop and supporting the temperature sensing electrical switch against the lower surface of the cooktop.

14. The gas cooking appliance of claim 13, wherein the mounting bracket comprises means for biasing the temperature sensing electrical switch against the lower surface of the cooktop.

15. The gas cooking appliance of claim 13, wherein the mounting bracket comprises a first flange and a second flange connected by an extension portion, wherein the first flange comprises a mounting aperture for the temperature sensing electrical switch and supports the temperature sensing electrical switch above and laterally off-set from the lower flange.

16. The gas cooking appliance of claim 15, wherein at least one of the first flange and the second flange form an angle of greater than 90 degrees with the extension portion.

17. The gas cooking appliance of claim 12, wherein the first, upper threshold is about 110 degrees Celsius and the second, lower threshold is about 101.5 degrees Celsius

18. The gas cooking appliance of claim 17, wherein the temperature sensing electrical switch comprises a snap-acting, bi-metal disc having an operating range of about 50 degrees Celsius to 250 degrees Celsius.

19. The gas cooking appliance of claim 12, wherein lead wires connect the temperature sensing electrical switch to a power source, and wherein the lead wires are affixed to the lower surface of the cooktop.
